(19) United States
(12) Patent Application Publication
(10) Pub. No.: US 2004/0208268 A1
(43) Pub. Date: Oct. 21, 2004

(54) Method of and apparatus for recovering a reference clock

(76) Inventor: Thomas Man Yin Ying, Wiltshire (GB)

Correspondence Address: MARK D. SARALINO (GENERAL), RENNER, OTTO, BOISELLE & SKLAR, LLP, 1621 EUCLID AVENUE, NINETEENTH FLOOR, CLEVELAND, OH, 44115-2191, US

(21) Appl. No.: 10/468,635

(22) PCT Filed: Jul. 18, 2003
(86) PCT No.: PCT/GB03/03146

(30) Foreign Application Priority Data
Aug. 3, 2002 (GB) 0218103.0

(51) Int. Cl. H04L 7/00

(52) U.S. Cl. 375/354

(57) ABSTRACT

An apparatus (21) is provided for recovering a reference clock generated by a master clock (22) in a sender (20). The sender (20) sends timing packets over a network (3). The apparatus comprises a controllable slave clock (27) and a control circuit (25, 26, 28) which determines the slave clock error and controls the slave clock (27) so as to reduce the error. The error is determined as a function of (m×N)−Cₐ(n), where

$${C}_{a} ( n ) = ( {\sum }_{i = 0}^{q - 1} C ( n - i ) ) / q .$$

N is the number of cycles of the master clock between the sending of consecutive timing information items, C(r) is the number of slave clock cycles between receipt of the (r−m)th and rth timing information items from the network, m is an integer greater than 0, and q is an integer greater than 1.

The control circuit (25,26,28) may alternatively or additionally be arranged to apply a correction V_{adj}(t) to the slave clock at regular intervals T_{adj}, and be arranged to apply a gain parameter dependent on the frequency difference between the master clock (22) and the slave clock (27) to each correction.

The present invention relates to a method of and an apparatus for recovering a reference clock. For example, such a method and apparatus may be used in the emulation of a time division multiplexed (TDM) circuit across a packet network, such as an Ethernet, an ATM network or an IP network.

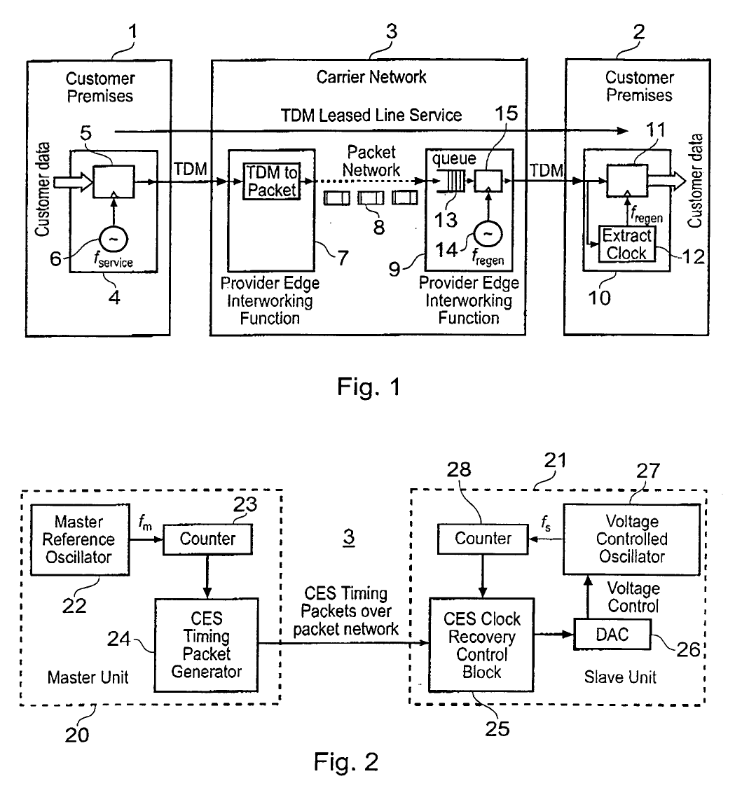

FIG. 1 of the accompanying drawings illustrates a known circuit emulation arrangement used to support the provision of leased line services to customers using legacy TDM equipment. The service is provided between a first customer premises 1 and a second customer premises 2 and the connection is provided via a packet switched carrier network 3.

The premises 1 is the transmitting or sending end of the connection and comprises an apparatus 4 which contains a circuit 5 controlled by a “master” clock 6. The circuit 5 receives customer data for transmission and organises this as a TDM transmission to the network 3.

The TDM link is a synchronous circuit with a constant bit rate governed by the service clock frequency f_{service} of the master clock 6. The TDM link is connected to an arrangement 7 of the network 3 performing a provider edge interworking function. In particular, the arrangement 7 converts the TDM data to data packets such as 8 and the packets are transmitted across the network 3 in accordance with the protocol of the network.

A further apparatus 9 is provided at the receiving end of the network to perform conversion of the packets to a TDM link for the premises 2. The regenerated TDM signals are then supplied to an apparatus 10 comprising an arrangement 11 for recovering the customer data controlled by a clock extraction circuit 12 supplying clock signals f_{regen}, which are required to reproduce exactly the service clock frequency f_{service}. The apparatus 9 comprises a queue 13 which receives and queues the packets received over the packet switched network. A clock 14 supplies a clock signal at a frequency f_{regen}, to a circuit 15, which effectively controls the reconstituting at the TDM signals.

In order for such an arrangement to operate correctly, it is essential for the regenerated clock frequency to match the master clock frequency in the apparatus 4. However, packet switched networks have no synchronisation between nodes so that the connection between the TDM ingress and egress frequencies is broken. The consequence of any long-term mismatch in frequency is that the queue 13 will fill up or empty depending on whether the regenerated clock is slower or faster than the master clock. This results in loss of data and degradation of the service.

The concept of adaptive clock recovery is known, for example from Circuit Emulation Services (CES) over ATM, ITU standard I.36.1 and ATM Forum standard AFVTOA-0078. However, details of actual techniques are not disclosed in these documents.

According to a first aspect of the invention, there is provided an apparatus for recovering a reference clock, generated by a master clock in a sender, from items of timing information sent by the sender over a network to the apparatus, comprising a controllable slave clock and a control circuit, characterised in that the control circuit is arranged to determine a slave clock error as a function of (m×N)−Cₐ(n), where

$${C}_{a} ( n ) = ( {\sum }_{i = 0}^{q - 1} C ( n - i ) ) / q$$

N is the number of cycles of the master clock between the sending of consecutive timing information items, C(r) is the number of slave clock cycles between receipt of the (r−m)th and rth timing information items from the network, m is an integer greater than zero, and q is an integer greater than one, and to control the slave clock so as to reduce the error.

The network may be a non-synchronous network, such as a packet switching network with each timing information item being a packet.

q may be less than or equal to m.

The control circuit may be arranged to determine the error as a function of

k[(m×N)−Cₐ(n)]/m

where k is the number of timing information items per second sent by the sender.

The slave clock may be a voltage controlled oscillator. The frequency of oscillation of the voltage controlled oscillator may be substantially equal to (a×V_{vco})+b, where V_{vco} is the control voltage of the voltage controlled oscillator and a and b are constants and the control circuit may be arranged to generate the control voltage as a function of:

$$\frac{k [ ( m \times N ) - Ca ( n ) ]}{a \times m}$$

The control circuit may be arranged to apply a correction to the slave clock at regular intervals T_{adj}.

The control circuit may be arranged to apply corrections

$${V}_{adj} ( t ) = d \times \frac{k [ ( m \times N ) - Ca ( n ) ]}{a \times m} .$$

where 0<d<1.

The control circuit may be arranged to apply a digital filter to each correction having programmable coefficients.

The control circuit may be arranged to apply a gain parameter to each correction given by:

$$G ( t ) = \frac{\vert ϵ ( t ) \vert}{α}$$

where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

The control circuit may be arranged to apply a gain parameter to each correction given by:

$$G ( t ) = \vert \frac{ϵ ( t )}{α \times ϵ ( t - 1 )} \vert$$

where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

According to a second aspect of the invention, there is provided a method of recovering a reference clock, generated by a master clock in a sender, from items of timing information sent by the sender over a network, comprising: determining a slave clock error as a function of (m×N)−Cₐ(n), where

$$Ca ( n ) = ( {\sum }_{i - 0}^{q - 1} C ( n - i ) ) / q$$

N is the number of cycles of the master clock between the sending of consecutive timing information items, C(r) is the number of slave clock cycles between receipt of the (r−m)th and rth timing information items from the network, m is an integer greater than zero, and q is an integer greater than one; and controlling a slave clock so as to reduce the error.

A third aspect of the invention provides an apparatus for recovering a reference clock, generated by a master clock in a sender, from items of timing information sent by the sender over a network to the apparatus, comprising a controllable slave clock and a control circuit for controlling the slave clock so as to reduce a slave clock error, characterised in that the control circuit is arranged to apply a correction V_{adj}(t) to the slave clock at regular intervals T_{adj}, and in that the control circuit is arranged to apply a gain parameter dependent on the frequency difference between the master clock and the slave clock to each correction.

This aspect of the invention allows the control system to adapt more dynamically if the frequency difference between the master and slave units is diverging. On the other hand, it restricts the magnitude of its control actions when the frequency difference detected is converging.

The control circuit may be arranged to apply a gain parameter to each correction given by:

$$G ( t ) = \frac{\vert ϵ ( t ) \vert}{α}$$

where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

The control circuit may be arranged to apply a gain parameter to each correction given by:

$$G ( t ) = \vert \frac{ϵ ( t )}{α \times ϵ ( t - 1 )} \vert$$

where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

A fourth aspect of the invention provides a method of recovering a reference clock, generated by a master clock in a sender, from items of timing information sent by the sender over a network to the apparatus, comprising applying a correction V_{adj}(t) to the slave clock at regular intervals T_{adj} so as to reduce a slave clock error, characterised in that the method comprises applying a gain parameter dependent on the frequency difference between the master clock and the slave clock to each correction.

It is thus possible to provide a technique which allows accurate reference clock recovery across a network such as a packet switched network. Thus, such a network may be used as part of a synchronous link which eliminates or substantially reduces data loss.

The invention will be further described, by way of example, with reference to the accompanying drawings, in which:

FIG. 1 is a block schematic diagram of a known arrangement for providing a TDM leased line service across a packet switched network;

FIG. 2 is a block schematic diagram illustrating a method of and an apparatus for providing adaptive clock recovery constituting an embodiment of the invention;

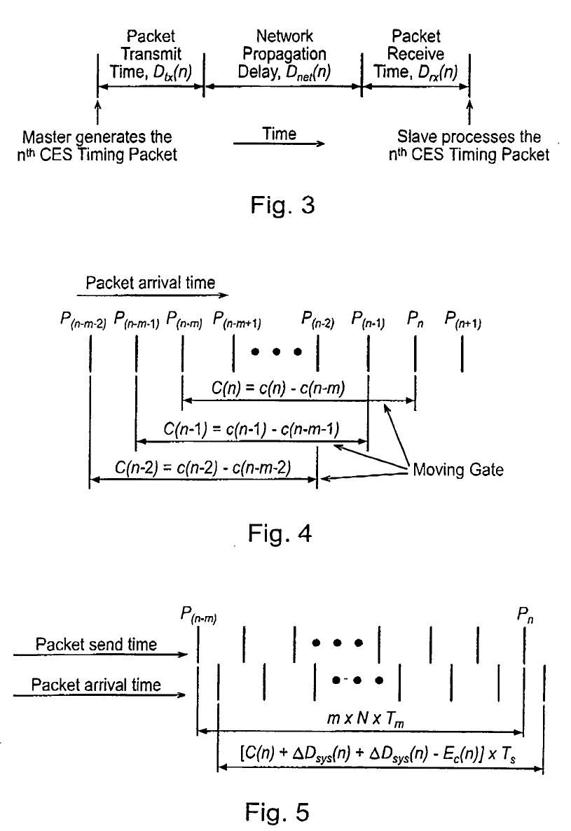

FIG. 3 illustrates the timing of generation and processing of a CES timing packet;

FIG. 4 illustrates a moving gate measurement process;

FIG. 5 illustrates a moving gate frequency measurement;

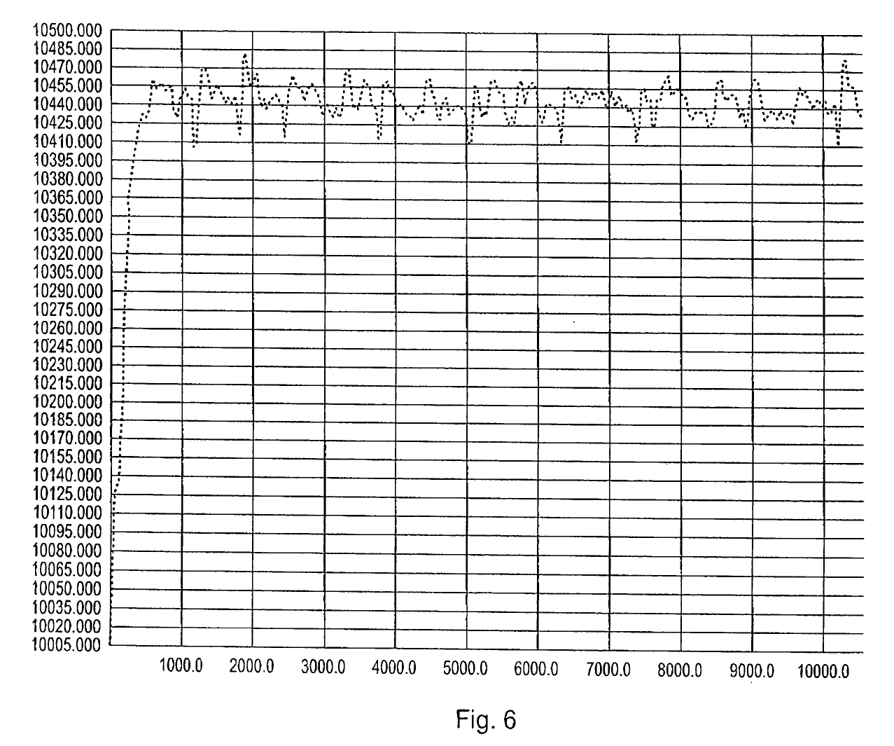

FIG. 6 is a graph illustrating slave clock output frequency in the absence of self-tuning; and

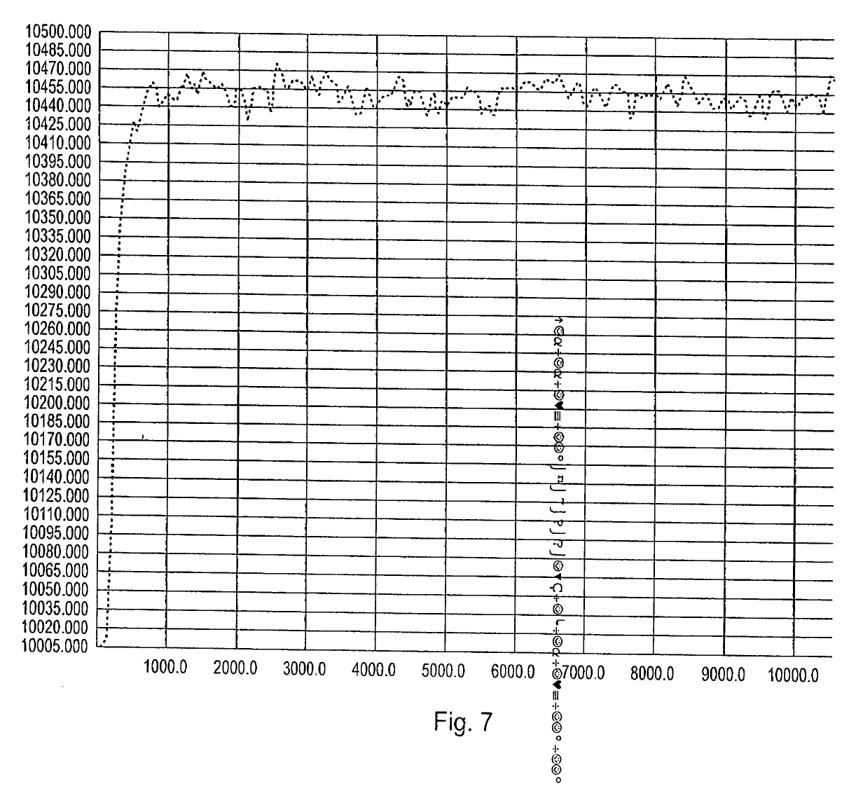

FIG. 7 is a graph illustrating slave clock output frequency in the presence of self-tuning

Like reference numerals refer to like parts throughout the drawings.

FIG. 2 illustrates a master unit 20 at the sending end of a TDM leased line service. The master unit 20 may be provided in the apparatus 4 at the customer premises 1 or in the arrangement 7 as part of the network 3. FIG. 2 also shows a slave unit 21 at the receiving end of the leased line service. The slave unit 21 may be provided in the circuit 9 of the network or in the apparatus 10 at the receiving premises 2.

The master unit 20 comprises a master reference oscillator 22 which forms a master clock supplying clock signals at a frequency fₘ. The clock signals are supplied to a counter 23 which divides the clock frequency by an integer and controls the generation of CES timing packets in a generator 24. In particular, for every N cycles of the master reference clock, the generator 24 generates and sends a CES timing packet to the slave unit 21 via the packet network 3.

The received timing packets are supplied to a clock recovery control block 25 in the slave unit 21. The output of the block 25 is supplied to a digital-analog converter (DAC) 26, which supplies a control voltage to a voltage controlled oscillator 27 acting as the slave clock whose frequency f, is to be synchronised to the master clock frequency fₘ. The output of the oscillator 27 is supplied to a counter 28, which supplies a “tick” count to the block 25.

The slave unit 21 performs a packet receive event for every CES timing packet received and records the current value of the tick count driven by the voltage controlled oscillator 27. The accumulated voltage controlled clock tick recorded for the nth CES timing packet, Pₙ, is referred as c(n). FIG. 3 shows the timing of the generation and processing of the CES timing packet by the master and slave units 20 and 21.

When the nth CES timing packet, Pₙ, is received by the slave unit 21 and the number of CES timing packets received is more than m since the adaptive clock system was initialised, the accumulated voltage controlled clock ticks between the arrival times of Pₙ and P₍ₙ₋ₘ₎ is equal to:

C(n)=c(n)−c(n−m) (1)

By taking into account the system operation latency variations and network latency variations under real operation conditions, C(n) can be expressed as:

C(n)=(m×N)+ΔD_{sys}(n)+ΔDₙₑₜ(n)−E_{c}(n) (2)

where:

(m×N) is the number of master reference clock cycles or ticks between the transmission times of Pₙ and P_{(n-m),}

ΔD_{sys}(n)=D_{sys}(n)−D_{sys}(n−m)=[Dₜₓ(n)+Dᵣₓ(n)]−[Dₜₓ(n−m)+Dᵣₓ(n−m)],

which is the variation in voltage controlled clock ticks caused by any system operation latency including time variations for transmitting and receiving network packets,

ΔDₙₑₜ(n)=Dₙₑₜ(n)−Dₙₑₜ(n−m),

which is the variation in voltage controlled clock ticks caused by any packet traffic latency present in the network, and

E_{c}(n) is the frequency error in voltage controlled clock ticks corresponding to the frequency differences between the master reference clock and the voltage controlled clock.

FIG. 4 illustrates the concept of a moving gate measurement. An average voltage controlled clock tick count for q consecutive moving gate measurements, Cₐ(n), is calculated as follows:

$${C}_{a} ( n ) = ( \frac{{\sum }_{i - 0}^{q - 1} C ( n - i )}{q} ) \qquad ( 3 )$$

$${C}_{a} ( n ) = ( \frac{{\sum }_{i = 0}^{q - 1} [ ( m \times N ) + Δ {D}_{sys} ( n - i ) + Δ {D}_{net} ( n - i ) - {E}_{c} ( n - i ) ]}{q} ) \qquad ( 4 )$$

Each C(n) is determined from the arrival times of two CES timing packets, Pₙ and Pₙ₋ₘ. The packet arrival time information of any CES timing packet should not be used more than once in the calculation of Cₐ(n). Otherwise, duplicated timing information is included in the average calculation and can lead to a less accurate result. This can be avoided by setting q to less than or equal to m.

The variation of the frequency differences between the master reference clock and the voltage controlled clock is insignificant over the measurement period of Cₐ(n), thus, E_{c}(n)=E_{c}(n−1)=E_{c}(n−2) and so on. Therefore, Cₐ(n) can be re-expressed as follows:

$${C}_{a} ( n ) = ( ( m \times N ) - {E}_{c} ( n ) + \frac{{\sum }_{i = 0}^{q - 1} Δ {D}_{sys} ( n - i )}{q} + \frac{{\sum }_{i = 0}^{q - 1} Δ {D}_{net} ( n - i )}{q} ) \qquad ( 5 )$$

Both system operation latency variations and network latency variations for the specific CES timing packet size are random. If sufficient timing samples are collected, then:

$$\begin{matrix}\frac{{\sum }_{i = 0}^{q - 1} Δ {D}_{sys} ( n - i )}{q} \to 0 \\ \frac{{\sum }_{i = 0}^{q - 1} Δ {D}_{net} ( n - i )}{q} \to 0\end{matrix}$$

Hence,

Cₐ(n)≅(m×N)−E_{c}(n) (6)

E_{c}(n)≅(m×N)−Cₐ(n) (7)

Both ΔD_{sys}(n) and ΔDₙₑₜ(n) are independent of m, N and q. This means that the greater the values of variables m, N and q are set to, the better the frequency measurement results which will be produced.

Measurement of the frequency error (in Hz), fₑᵣᵣ, between the master and the slave units 20, 21 is illustrated in FIG. 5. The periods of the voltage controlled clock and the master reference clock are Tₛ and Tₘ, respectively. For each measurement gate:

m×N×Tₘ=[C(n)+ΔD_{sys}(n)+ΔD_{sys}(n)−E_{c}(n)]×Tₛ

By averaging q consecutive moving gate measurements:

m×N×Tₘ≅Cₐ(n)×Tₛ

Substituting equation (6) gives:

m×N×Tₘ=[(m×N)−E_{c}(n)]×Tₛ (8)

The voltage controlled clock and the master reference clock frequencies are fₛ and fₘ, respectively. If the master unit sends k packets every one second, then:

$$\begin{matrix}{f}_{m} = \frac{1}{{T}_{m}} , {f}_{s} = \frac{1}{{T}_{s}} and N = \frac{1}{k} \times {f}_{m} \\ m \times \frac{1}{k} \times {f}_{m} \times {T}_{m} = ( m \times \frac{1}{k} \times {f}_{m} - {E}_{c} ( n ) ) \times {T}_{s} \\ \frac{m}{k \times {T}_{s}} = \frac{m \times {f}_{s}}{k} = \frac{m \times {f}_{m}}{k} - {E}_{c} ( n ) \\ m \times [ {f}_{m} - {f}_{s} ] = k \times {E}_{c} ( n ) \\ {f}_{err} = {f}_{m} - {f}_{s} = \frac{k \times {E}_{c} ( n )}{m}\end{matrix} \qquad ( 9 )$$

where fₑᵣᵣ is the frequency adjustment in Hz required to correct the voltage controlled clock frequency in the slave until 21 to match the master reference clock frequency. If the voltage controlled oscillator has a linear response as follows:

f_{vco}=a×V_{vco}+b

where a and b are the characteristic constants of the voltage controlled oscillator, and V_{vco} is the voltage applied to the voltage controlled oscillator to control the output frequency, then Δf_{vco}=a×ΔV_{vco},

To correct the frequency error in the Slave unit 21 (Δf_{vco}=fₑᵣᵣ), the voltage controlled adjustment required is therefore:

$${f}_{err} = \frac{k \times {E}_{c} ( n )}{m} = a \times {V}_{err} ⇒ {V}_{err} = \frac{k \times {E}_{c} ( n )}{a \times m} \qquad ( 10 )$$

Substituting equation (7) into equation (10) gives:

$${V}_{err} = \frac{k \times [ ( m \times N ) - {C}_{a} ( n ) ]}{a \times m} \qquad ( 11 )$$

The values of m, N, k and a are known and Cₐ(n) is measured so that the appropriate voltage adjustment to be applied to the voltage controlled oscillator 27 in order to correct any frequency error is calculated using equation (11).

In a typical example, the master frequency, fₘ=2048000 Hz. The master unit 20 sends one CES timing packet to the slave unit 21 every one second so that k=1 and N=fₘ/k=2048000. Also, m=2, q=2, and the arrival times (in slave unit clock ticks) for the first four consecutive packets are 2048005, 4096009, 6144016 and 8192020.

From equation (1):

C(n)=c(n)−c(n−m)

C(2)=c(2)−c(0)=6144016−2048005=40960011

C(3)=c(3)−c(1)=8192020−4096009=40960011

Using equation (3):

$${C}_{a} ( n ) = ( \frac{{\sum }_{i - 0}^{q - 1} C ( n - i )}{q} )$$

Cₐ(3)=[C(3)+C(2)]/2=40960011

Using equations (3) and (9):

E_{c}(n)≅(m×N)−Cₐ(n)

E_{c}(3)≅(2×2048000)−Cₐ(3)=40960000−40960011=11

$$\begin{matrix}{f}_{err} = {f}_{m} - {f}_{s} = \frac{k \times {E}_{c} ( n )}{m} \\ {f}_{err} = \frac{1 \times 11}{2} = 5.5 Hz\end{matrix}$$

If the voltage controlled oscillator has a linear response with 1/16^{th} of a Hz per step, then

$$\begin{matrix}a = \frac{1}{16} , and \\ {V}_{err} = \frac{{f}_{err}}{a} = 16 \times 5.5 = 88\end{matrix}$$

This control technique may be modified to provide fast tracking frequency control of the slave unit 21. This scheme is specifically tailored to handle situations where the frequency error between the master and the slave units 20, 21 can be large (>20 Hz) or unknown during the system initialisation phase. The slave unit is programmed to adjust the voltage controlled frequency at a user-defined interval, T_{adj}.

Using equation (11):

$${V}_{adj} ( t ) = d \times {V}_{err} ( t ) = d \times \frac{k \times [ ( m \times N ) - {C}_{a} ( n ) ]}{a \times m} \qquad ( 12 )$$

where:

t=T_{adj},2T_{adj},3T_{adj} and so on,

Vₑᵣᵣ(t) is the voltage controlled error measured at time t,

V_{adj}(t) is the voltage controlled adjustment to be applied at time t,

Cₐ(n) is the most recent sample of Cₐ at time t, and

d should be set to between 0<d<1 for the appropriate response. A value of 0.7 means the frequency adjustment is 70% of the total frequency error detected between the Master and the Slave units.

In a typical example, the frequency error between the master and the slave units 20, 21, fₑᵣᵣ is 10 Hz at time T_{adj}. If the master frequency is constant and the value of d is set to 0.7:

At time T_{adj},fₑᵣᵣ(t)=10.00 Hz,V_{adj}(t)=0.7×Vₑᵣᵣ(t).

At time 2T_{adj},fₑᵣᵣ(t+1)=3.00 Hz,V_{adj}(t+1)=0.7×Vₑᵣᵣ(t+1)=0.21×Vₑᵣᵣ(t).

At time 3T_{adj},fₑᵣᵣ(t+2)=0.09 Hz,V_{adj}(t+2)=0.7×Vₑᵣᵣ(t+2)=0.063×Vₑᵣᵣ(t).

A further modification provides flexible programmable control of the frequency adjustment of the slave unit 21. With this control scheme, a programmable difference equation is provided to tailor the control response of the CES adaptive clock system in the following form

$$H ( z ) = \frac{{\sum }_{i = 0}^{k} {b}_{i} {z}^{- i}}{{\sum }_{p = 0}^{L} {a}_{p} {z}^{- p}} \qquad ( 13 )$$

where:

H(z) is the programmable difference equation filter in z-transform,

K is a constant that determines H(z) has K z-Plane Zeros.

L is a constant that determines H(z) has L z-Plane Poles.

a₀, a₁, . . . , aₖ and b₀, b₁, . . . , b_{L} are the programmable coefficients of the difference equation.

The voltage controlled frequency is adjusted at a user-defined interval, Ta, in accordance with:

a₀×V_{adj}(t)+a₁×V_{adj}(t−1)+ . . . +a_{L}×V_{adj}(t−L)=b₀×Vₑᵣᵣ(t))+b₁×Vₑᵣᵣ(t−1)+ . . . +bₖ×Vₑᵣᵣ(t−K)

V_{adj}(t)=[b₀×Vₑᵣᵣ(t)+b₁×Vₑᵣᵣ(t−1)+ . . . +bₖ×Vₑᵣᵣ(t−K)−a₁×V_{adj}(t−1)− . . . −a_{L}×V_{adj}(t−L)/a₀ (14)

where:

t is in frequency adjustment time units (i.e. every T_{adj}),

Vₑᵣᵣ(t) is the voltage controlled error measured at time t, and

V_{adj}(t) is the voltage controlled adjustment to be applied at time t.

The programmable equation can be programmed to generate different types of control responses. For example, using equation (14) with a₀ set equal to 1 and a₁ to a_{L} all set equal to zero:

V_{adj}(t)=b₀×Vₑᵣᵣ(t)+b₁×Vₑᵣᵣ(t−1)+ . . . +bₖ×Vₑᵣᵣ(t−K) (15)

The control response then becomes based on a FIR (infinite impulse response) filter with coefficients b₀, b₁, . . . , bₖ.

This technique may be further modified to provide self-tuning by adding an extra self-tuning gain parameter dependent on the frequency error between the master clock and the slave clock to each correction. This allows the control system to adapt more dynamically if the frequency difference between the master and slave units is diverging. On the other hand, it restricts the magnitude of its control actions when the frequency difference detected is converging. This aspect of the invention may be applied in conjunction with, or separately from, the above-described aspect

In one preferred embodiment, this aspect of the invention comprises adding an extra self-tuning gain parameter to the control system such that:

V_{adj}(t)=G(t)×[b₀×Vₑᵣᵣ(t)+b₁×Vₑᵣᵣ(t−1) . . . +bₖ×Vₑᵣᵣ(t−K)−a₁×V_{adj}(t−1)− . . . −a_{L}×V_{adj}(t−L)]/a₀ (16)

$$G ( t ) = \frac{\vert ϵ ( t ) \vert}{a} \qquad ( 17 )$$

ε(t)=β×fₑᵣᵣ(t)+(1−β)×ε(t−1) (18)

where:

t is in frequency adjustment time units (i.e. every T_{adj}),

G(t) is the self-tuning gain control parameter.

ε(t) is the filtered average frequency error at time t.

α is the gain control scaling factor and should be set to greater than one.

β is the forgetting factor for the average frequency error. This should be set such that 0<β<1.

fₑᵣᵣ(t) is frequency error in Hz at time t.

The filtered average frequency error, ε(t), indicates the trend of the frequency error between the master and the slave units. It is calculated based on the recursive equation (18). The forgetting factor, β, determines the balance of the effects between the most recent frequency error and the previous frequency errors. If β is equal to 0.3:

ε(t)=0.3×fₑᵣᵣ(t)+0.7×ε(t−1)=0.3×fₑᵣᵣ(t)+0.21×fₑᵣᵣ(t−1)+0.49×ε(t−2)

The self-tuning gain, G(t), is directly proportional to ε(t). This means that as the frequency error between the master and the slave units diverges, ε(t) will increase which will lead to a larger G(t) and more dynamic control actions to correct the frequency error. To ensure the stability of the control system, an upper limit should be applied to G(t). A lower limit for G(t) is preferably also applied to ensure that, over a long period of time, the slave frequency is above the master frequency for approximately the same amount of time as it is below the master frequency.

In a typical example, the gain control scaling factor, α, is equal to 100. Also, G(t) is limited to 0<G(t)<1.

If ε(t)>100 Hz, G(t)=1.

If ε(t)=5 Hz, G(t)=0.05.

If ε(t)=1 Hz, G(t)=0.01.

Two tests were performed with and without the self-tuning control mechanism to illustrate its effectiveness. All other components are configured to be the same. The results are shown in FIG. 6 and FIG. 7.

The master reference clock was set at 2048145 Hz and the targetted voltage control for the slave was 10453. The slave and the master units were connected via an Ethernet Switch with no other component on the network. The network was then loaded with 70% full-duplex traffic at 100 Mbit/s.

The averaging parameters were:

m=8, N=256000, k=8, q=32

The CES timing packet rate was 8 packets per second. To avoid reusing timing information from any packet arrival time, the averaging was carried out as the average of four blocks of moving gates.

The coefficients of the difference equation were:

Bᵢ=[0.008 0.025 0.025 0.008], aₚ[1.000 −0262 0.237 −0.073].

The self-tuning control parameters were:

α=100, β=0.2, 0<G(t)<1.

The y-axis is in voltage control steps (approximately 15 steps per Hz). The x-axis of the graph is in CES timing packet count (8 packet/s). The results suggest that the self-tuning algorithm provides a more stable response within +/−0.7 ppm.

Various modifications may be made; for example, a more accurate modelling of the voltage controlled oscillator response may be adopted for the moving gate averaging. Instead of using a single linear gradient to convert the voltage applied into output frequency over the full scale, the dynamic range of the voltage controlled oscillator 27 may be divided into several bands. An individual gradient is calibrated for each band and used in equations (10) and (11). This reduces the effect of any non-linearity of the voltage controlled oscillator and may result in more accurate estimation of the required control actions.

Also, the self-tuning arrangement may have the self-tuning gain control parameter calculated as:

$$G ( t ) = \vert \frac{ϵ ( t )}{a \times ϵ ( t - 1 )} \vert \qquad ( 19 )$$

This variation provides an alternative convergence detection based on the ratio of the current and previous filtered average frequency errors.

1. An apparatus for recovering a reference clock, generated by a master clock (22) in a sender (20), from items of timing information sent by the sender (20) over a network (3) to the apparatus, comprising a controllable slave clock (27) and a control circuit (25), characterised in that the control circuit (25) is arranged to determine a slave clock error as a function of (m×N)−Cₐ(n), where:
$${C}_{a} ( n ) = ( {\sum }_{i = 0}^{q - 1} C ( n - i ) ) / q$$
N is the number of cycles of the master clock (22) between the sending of consecutive timing information items, C(r) is the number of slave clock cycles between receipt of the (r−m)th and rth timing information items from the network (3), m is an integer greater than zero, and q is an integer greater than one, and to for control the slave clock (27) so as to reduce the error.

2. An apparatus as claimed in claim 1, characterised in that the network (3) is a non-synchronous network.

3. An apparatus as claimed in claim 2, characterised in that the network (3) is a packet switching network and each timing information item is a packet.

4. An apparatus as claimed in any one of the preceding claims, characterised in that q≦m.

5. An apparatus as claimed in any one of the preceding claims, characterised in that the control circuit (25) is arranged to determine the error as a function of:
k[(m×N)−Cₐ(n)]/m
where k is the number of timing information items per second sent by the sender (20).

6. An apparatus as claimed in any one of the preceding claims, characterised in that the slave clock (27) is a voltage controlled oscillator.

7. An apparatus as claimed in claim 6 when dependent on claim 5, characterised in that the frequency of oscillation of the voltage controlled oscillator (27) is substantially equal to (a×V_{vco})+b, where V_{vco} is the control voltage of the voltage controlled oscillator (27) and a and b are constants and the control circuit (25) is arranged to venerate the control voltage as a function of:
$$\frac{k [ ( m \times N ) - Ca ( n ) ]}{a \times m}$$

8. An apparatus as claimed in any one of the preceding claims, characterised in that the control circuit (25) is arranged to apply a correction to the slave clock (27) at regular intervals T_{adj}.

9. An apparatus as claimed in claim 8 when dependent on claim 7, characterised in that the control circuit (25) is arranged to apply corrections V_{adj}(t), for t=T_{adj}, 2T_{adj}, 3T_{adj}, . . . given by:
$${V}_{adj} ( t ) = d \times \frac{k [ ( m \times N ) - Ca ( n ) ]}{a \times m} .$$
where 0<d<1.

10. An apparatus as claimed in claim 8, characterised in that the control circuit (25) is arranged to apply a digital filter to each correction having programmable coefficients.

11. An apparatus as claimed in claim 10, characterised in that the control circuit (25) is arranged to apply a gain parameter to each correction given by:
$$G ( t ) = \frac{\vert ϵ ( t ) \vert}{α}$$
where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

12. An apparatus as claimed in claim 10, characterised in that the control circuit (25) is arranged to apply a gain parameter to each correction given by:
$$G ( t ) = \vert \frac{ϵ ( t )}{α \times ϵ ( t - 1 )} \vert$$
where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

13. A method of recovering a reference clock, generated by a master clock (22) in a sender (20), from items of timing information sent by the sender (20) over a network (3), comprising: determining a slave clock error as a function of (m×N)−Cₐ(n), where
$${C}_{a} ( n ) = ( {\sum }_{i = 0}^{q - 1} C ( n - i ) ) / q$$
N is the number of cycles of the master clock (22) between the sending of consecutive timing information items, C(r) is the number of slave clock cycles between receipt of the (r−m)th and rth timing information items from the network (3), m is an integer greater than zero, and q is an integer greater than one; and controlling a slave clock (27) so as to reduce the error.

14. An apparatus for recovering a reference clock, generated by a master clock (22) in a sender (20), from items of timing information sent by the sender (20) over a network (3) to the apparatus, comprising a controllable slave clock (27) and a control circuit (25) for controlling the slave clock (27) so as to reduce a slave clock error, characterised in that the control circuit (25) is arranged to apply a correction V_{adj}(t) to the slave clock (27) at regular intervals T_{adj}, and in that the control circuit (25) is arranged to apply a gain parameter dependent on the frequency difference between the master clock (22) and the slave clock (27) to each correction.

15. An apparatus as claimed in claim 14, characterised in that the control circuit (28) is arranged to apply a gain parameter to each correction given by:
$$G ( t ) = \frac{\vert ϵ ( t ) \vert}{α}$$
where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<, <1, and fₑᵣᵣ(t) is the frequency error in Hz at time t.

16. An apparatus as claimed in claim 14, characterised in that the control circuit (25) is arranged to apply a gain parameter to each correction given by:
$$G ( t ) = \vert \frac{ϵ ( t )}{α \times ϵ ( t - 1 )} \vert$$
where ε(t)=(β×fₑᵣᵣ(t))+((1−β)×ε(t−1)), ε(t) is the filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

17. A method of recovering a reference clock, generated by a master clock (22) in a sender (20), from items of timing information sent by the sender (20) over a network (3) to the apparatus, comprising applying a correction V_{adj}(t) to a slave clock (27) at regular intervals T_{adj} so as to reduce a slave clock error, characterised in that the method comprises applying a gain parameter dependent on the frequency difference between the master clock (22) and the slave clock (27) to each correction.

18. An apparatus for recovering a reference clock, generated by a master clock in a sender, from items of timing information sent by said sender over a network to said apparatus, said apparatus comprising a controllable slave clock and a control circuit for determining a slave clock error as a function of (m×N)−Cₐ(n), where:
$${C}_{a} ( n ) = ( {\sum }_{i = 0}^{q - 1} C ( n - i ) ) / q$$
N is a number of cycles of said master clock between sending of consecutive ones of said timing information items, C(r) is a number of slave clock cycles between receipt of the (r−m)th and rth ones of said timing information items from said network, m is an integer greater than zero, and q is an integer greater than one, and for controlling said slave clock so as to reduce said error.

19. An apparatus as claimed in claim 18, in which said network is a non-synchronous network.

20. An apparatus as claimed in claim 19, in which said network is a packet switching network and each said timing information item is a packet.

21. An apparatus as claimed in any one of the preceding claims 18, in which q≦m.

22. An apparatus as claimed in claim 18, in which said control circuit is arranged to determine said error as a function of:
k[(m×N)−Cₐ(n)]/m
where k is a number of said timing information items per second sent by said sender.

23. An apparatus as claimed in claim 18, in which said slave clock is a voltage controlled oscillator.

24. An apparatus as claimed in claim 22, in which said slave clock is a voltage controlled oscillator and a frequency of oscillation of said voltage controlled oscillator is substantially equal to (a×V_{vco})+b, where V_{vco} is a control voltage of said voltage controlled oscillator and a and b are constants and said control circuit is arranged to generate said control voltage as a function of:
$$\frac{k [ ( m \times N ) - Ca ( n ) ]}{a \times m}$$

25. An apparatus as claimed in claim 18, in which said control circuit is arranged to apply a correction to said slave clock at regular intervals T_{adj}.

26. An apparatus as claimed in claim 24, in which said control circuit is arranged to apply a correction to said slave clock at regular intervals T_{adj} and said apply corrections V_{adj}(t), for t=T_{adj}, 2T_{adj}, 3T_{adj}, are given by:
$${V}_{adj} ( t ) = d \times \frac{k [ ( m \times N ) - Ca ( n ) ]}{a \times m} .$$
where 0<d<1.

27. An apparatus as claimed in claim 25, in which said control circuit is arranged to apply a digital filter to each said correction having programmable coefficients.

28. An apparatus as claimed in claim 27, in which said control circuit is arranged to apply a gain parameter to each said correction given by:
$$G ( t ) = \frac{\vert ϵ ( t ) \vert}{α}$$
where ε(t)=(β×fₑᵣᵣ(t))+((1−β)×ε(t−1)), ε(t) is a filtered average frequency error at time t=T_{adj}, 2T_{adj}, 3T_{adj}, . . . , α is a scaling factor greater than one, 0<β<1, and fₑᵣᵣ(t) is the frequency error in Hz at time t.

29. An apparatus as claimed in claim 27, in which said control circuit is arranged to apply a gain parameter to each said correction given by:
$$G ( t ) = \vert \frac{ϵ ( t )}{α \times ϵ ( t - 1 )} \vert$$
where ε(t)=(β×fₑᵣᵣ(t))+((1−β)×ε(t−1)), ε(t) is a filtered average frequency error at time t=T_{adj}, 2T_{adj}, 3T_{adj}, . . . , α is a scaling factor greater than one, 0<β<1, and fₑᵣᵣ(t) is a frequency error in Hz at time t.

30. A method of recovering a reference clock, generated by a master clock in a sender, from items of timing information sent by said sender over a network, comprising: determining a slave clock error as a function of (m×N)−Cₐ(n), where
$$Ca ( n ) = ( {\sum }_{i = 0}^{q - 1} C ( n - i ) ) / q$$
N is a number of cycles of said master clock between sending of consecutive ones of said timing information items, C(r) is a number of slave clock cycles between receipt of (r−m)th and rth ones of said timing information items from said network, m is an integer greater than zero, and q is an integer greater than one; and controlling a slave clock so as to reduce said error.

31. An apparatus for recovering a reference clock, generated by a master clock in a sender, from items of timing information sent by said sender over a network to said apparatus, send apparatus comprising a controllable slave clock and a control circuit for controlling said slave clock so as to reduce a slave clock error, in which said control circuit is arranged to apply a correction V_{adj}(t) to said slave clock at regular intervals T_{adj}, and in which said control circuit is arranged to apply a gain parameter dependent on a frequency difference between said master clock and said slave clock to each said correction.

32. An apparatus as claimed in claim 31, in which said control circuit is arranged to apply said gain parameter to each correction given by:
$$G ( t ) = \frac{\vert ϵ ( t ) \vert}{α}$$
where ε(t) (β×fₑᵣᵣ(t))+((1−β)×ε(t−1)), ε(t) is a filtered average frequency error at time t=T_{adj}, 2T_{adj}, 3T_{adj}, . . . , α is a scaling factor greater than one, 0<β<1, and fₑᵣᵣ(t) is a frequency error in Hz at time t.

33. An apparatus as claimed in claim 31, in which said control circuit is arranged to apply said gain parameter to each said correction given by:
$$G ( t ) = \vert \frac{ϵ ( t )}{α \times ϵ ( t - 1 )} \vert$$
where ε(t)=(β×fₑᵣᵣ(t))+((1−β)×ε(t−1)), ε(t) is a filtered average frequency error at time t=T_{adj}, 2T_{adj}, 3T_{adj}, . . . , α is a scaling factor greater than one, 0<β<1, and fₑᵣᵣ(t) is a frequency error in Hz at time t.

34. A method of recovering a reference clock, generated by a master clock in a sender, from items of timing information sent by said sender over a network to said apparatus, said method comprising applying a correction V_{adj}(t) to said slave clock at regular intervals T_{adj} so as to reduce a slave clock error, and applying a gain parameter dependent on a frequency difference between said master clock and said slave clock to each said correction.
